(19) United States
(12) Patent Application Publication
(10) Pub. No.: US 2026/0166456 A1
(43) Pub. Date: Jun. 18, 2026

(54) METHOD AND SYSTEM FOR ESTIMATING REMAINING USEFUL LIFE OF FUEL FILTER

(71) Applicant: Caterpillar Inc., Peoria, IL (US)

(72) Inventors: Michael T. McKINLEY, Washington, IL (US); Ye TIAN, Bloomington, IL (US); Sravan K. KARRI, Dunlap, IL (US); Venkataraman Narayanan VENKATESAN, Chennai (IN)

(73) Assignee: Caterpillar Inc., Peoria, IL (US)

(21) Appl. No.: 18/984,052

(22) Filed: Dec. 17, 2024

(51) Int. Cl. B01D 35/143; B01D 29/56; B01D 35/00; G01N 15/08

(52) U.S. Cl. CPC B01D 35/1435; B01D 29/56; B01D 35/005; G01N 15/0826; G01N 2015/084

(57) ABSTRACT

A fuel filter monitoring system may include a fuel supply system including a primary fuel filter and a secondary fuel filter, a sensor system, and a controller configured to estimate a remaining life associated with the primary fuel filter based on the barometric pressure signal and the fuel pressure signal. The sensor system may include a barometric pressure sensor, and a fuel pressure sensor connected downstream of the secondary fuel filter, the sensor system being configured to generate a barometric pressure signal with the barometric pressure sensor and a fuel pressure signal with the fuel pressure sensor.

### TECHNICAL FIELD

This disclosure relates generally to fuel filters, and, more particularly, to methods and systems for determining the remaining useful life of a fuel filter.

### BACKGROUND

Internal combustion engines benefit from the use of fuel filters that remove debris that is sometimes present in fuel, such as diesel fuel. To effectively remove different types of particles, some systems include a plurality of fuel filters, sometimes referred to as primary and secondary fuel filters. A primary fuel filter, located upstream of a secondary fuel filter, can be provided with filter media that removes larger particles as compared to the secondary fuel filter. While fuel filters are effective, over time they can accumulate material and become clogged. This can slow the flow of fuel to the engine and negatively impact the ability of the filter to function.

It is therefore beneficial to predict the remaining useful life (“RUL”) of fuel filters, including systems containing a primary fuel filter and a secondary fuel filter, to avoid prematurely replacing a fuel filter or allowing an underperforming filter to remain installed. Some methods for predicting the RUL of a primary fuel filter, for example, involve monitoring the pressure of fuel at various locations of the system. However, at least some systems lack a filter sensor immediately downstream of the primary fuel filter, preventing these systems from monitoring the RUL of this fuel filter. Systems with three or more fuel pressure sensors may have additional diagnostic abilities but introduce increased costs and complexity due to the additional pressure sensor and wiring harness.

A fuel supply system is disclosed in U.S. Patent No. 8,844,503 (the ’503 patent) to Worthington et al. The system described in the ’503 patent includes series of filters and sensors that are used to determine the need for changing a filter element. The sensors in the ’503 patent provide filter element loading data, such as draw or downstream pressure. While the system described in the ’503 patent may be useful in some circumstances, the use of filter element loading data may involve placement of a pressure sensor between a first stage of filtration and a fuel transfer pump.

The systems and methods of the present disclosure may solve one or more of the problems set forth above and/or other problems in the art. The scope of the current disclosure, however, is defined by the attached claims, and not by the ability to solve any specific problem.

### SUMMARY

In one aspect, a fuel filter monitoring system is disclosed. The system may include a fuel supply system including a primary fuel filter and a secondary fuel filter, a sensor system, and a controller configured to estimate a remaining life associated with the primary fuel filter based on the barometric pressure signal and the fuel pressure signal. The sensor system may include a barometric pressure sensor, and a fuel pressure sensor connected downstream of the secondary fuel filter, the sensor system being configured to generate a barometric pressure signal with the barometric pressure sensor and a fuel pressure signal with the fuel pressure sensor.

In another aspect, a fuel filter monitoring method is disclosed. The method may include receiving a barometric pressure signal from a barometric pressure sensor of a fuel supply system, the fuel supply system including a first fuel filter and a second fuel filter, the second fuel filter being connected downstream of the first fuel filter, receiving a fuel pressure signal from a fuel pressure sensor of the fuel supply system, the fuel pressure sensor being connected downstream of the second fuel filter, and determining a remaining useful life of the first fuel filter based on the barometric pressure signal and the fuel pressure signal.

In a further aspect, a method for monitoring a fuel filter is disclosed. The method may include receiving an atmospheric pressure signal from a pressure sensor of a fuel supply system, receiving a fuel pressure signal from a fuel pressure sensor of the fuel supply system, the fuel pressure sensor being connected downstream of a first fuel filter and downstream of a second fuel filter, determining a pressure at a location downstream of the first fuel filter based on the atmospheric pressure signal and the fuel pressure signal, and determining a remaining useful life of the first fuel filter based on the determined pressure.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic view of a system for determining RUL of a primary fuel filter, according to aspects of the disclosure.

FIG. 2 illustrates a block diagram an electronic control module for the system of FIG. 1.

FIG. 3 is a chart depicting an exemplary barometric pressure and fuel pressure downstream of a secondary filter for the system of FIG. 1.

FIG. 4 is a chart depicting determined fuel pressure downstream of a primary fuel filter for the system of FIG. 1.

FIG. 5 illustrates a flowchart for a method of predicting RUL of a fuel filter, according to aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about,” “substantially,” “generally,” and “approximately” are used to indicate a possible variation of ±10% in the stated value or characteristic.

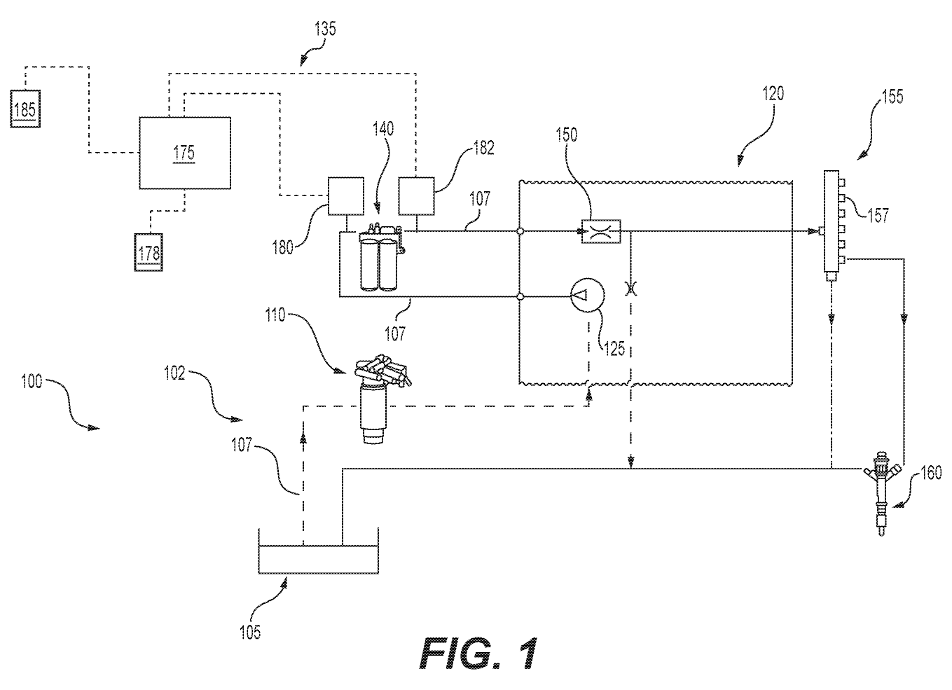

FIG. 1 below shows a fuel monitoring system 100 for predicting RUL of a fuel filter, such as primary fuel filter 110. Fuel filter monitoring system 100 may include an internal combustion engine (not shown), a fuel system 102, and a sensor system 135. Monitoring system 100 may include a control system having one or more controllers, such as electronic control module (ECM) 175. Fuel filter monitoring system 100 may also include one or more devices for displaying a prompt, warning, or other notification to one or more users, such as a notification device 185.

Fuel system 102 of system 100 may supply fuel to injectors 160. In the exemplary configuration illustrated in FIG. 1, fuel system 102 includes a fuel source 105, such as a fuel tank, fuel lines 107, and a pressurized fuel rail or common rail 155. Fuel rail 155 may include a plurality of outlets 157 connected to a respective plurality of fuel injectors 160 to inject fuel (e.g., liquid fuel, such as diesel fuel). While one injector 160 is shown in FIG. 1, the engine may include any number of injectors 160, such as six, eight, ten, twelve, sixteen, twenty or more.

Fuel system 102 may also include a plurality of fuel filters, including a primary fuel filter 110 and a secondary fuel filter 140. While the terms “primary” and “secondary” are used herein, use of these terms does not limit the filter to a particular type. Rather, as used herein, a “primary” fuel filter is connected upstream of a “secondary” fuel filter. Primary fuel filter 110 may be a first fuel filter, while fuel filter 140 may be a second fuel filter. Filters 110 and 140 may include a single filter element or may be provided as an assembly containing multiple filter elements.

Filters 110 and 140 may be connected to fuel source 105 by fuel lines 107. As shown in FIG. 1, primary fuel filter 110 may be fluidly connected upstream of a fuel pump 125 (e.g., a feed pump or fuel supply pump). Secondary filter 140 may be connected between fuel pump 125 and a pressurizing pump, such as high fuel pressure pump 120. As understood, a pressure of fuel at the outlet of high pressure pump 120 may be greater than a pressure of the fuel at the outlet of pump 125. High pressure pump 120 may include an inlet metering valve 150 to control supply of fuel, as well as components for increasing the pressure of fuel to a level that is suitable for injection via injectors 160.

If desired, fuel pump 125 may be connected to or incorporated in high pressure fuel pump 120, which supplies pressurized fuel to a common fuel rail 155 upstream of fuel injectors 160. While fuel pump 125 is connected downstream of fuel filter 110 in the exemplary configuration shown in FIG. 1, fuel pump 125 may instead be connected upstream of both primary fuel filter 110 and secondary fuel filter 140, or a plurality of fuel pumps 125 may be included in fuel system 102.

Sensor system 135 may include sensors for monitoring fuel system conditions. In particular, sensor system 135 may include sensors useful for monitoring a remaining life of a fuel filter, such as sensors configured to detect altitude and/or geographic location, atmospheric pressure, fuel pressure associated with primary fuel filter 110, fuel pressure at an inlet of secondary fuel filter 140, fuel pressure at an outlet of secondary fuel filter 140, fuel temperature, and fuel flow. As shown in FIG. 1, sensor system 135 may include a pre-secondary fuel pressure sensor 180, a post-secondary fuel pressure sensor 182, and a barometric pressure sensor 178. As used herein, the phrase “pre-secondary” refers to a sensor connected upstream of filter 140, while “post-secondary” refers to a sensor connected downstream of filter 140. In some embodiments, fuel system 102 does not include a fuel pressure sensor connected between primary filter 110 and fuel pump 125. Thus, the only sensor connected between filters 110 and 140 may be sensor 180, which is connected closer to an inlet of filter 140 than to an outlet of filter 110. In some aspects, sensor 180 may be connected immediately upstream of an inlet of filter 140.

Barometric pressure sensor 178 may be configured to measure atmospheric pressure, also referred to herein as barometric pressure. Pre-secondary pressure sensor 180 and post-secondary pressure sensor 182 may be configured to measure pressures of fuel associated with secondary fuel filter 140, both pressures being measured downstream of pump 125 and upstream of the high-pressure pumping components (not shown) of high pressure fuel pump 120, these components being downstream of inlet metering valve 150. Pre-secondary pressure sensor 180 may measure the pressure at an inlet of secondary fuel filter 140. Post-secondary pressure sensor 182 may measure the pressure at an outlet of secondary fuel filter 140. In some embodiments, pre-secondary fuel filter sensor 180 or post-secondary fuel filter sensor 182 may be further configured to measure fuel temperature or other characteristics of fuel that are associated with RUL of a fuel filter. In other embodiments, fuel temperature may be measured by sensors other than sensors 180 or 182. Further, an engine speed sensor may be used to generate a signal that indicates a speed of the internal combustion engine, which can be used by ECM 175 to determine fuel flow.

In one aspect, ECM 175 of system 100 may monitor conditions of system 100 via sensor system 135. ECM 175 may include a single microprocessor or multiple microprocessors configured to receive sensed inputs from sensor system 135 and predict the RUL of primary filter 110 based on the sensed inputs.

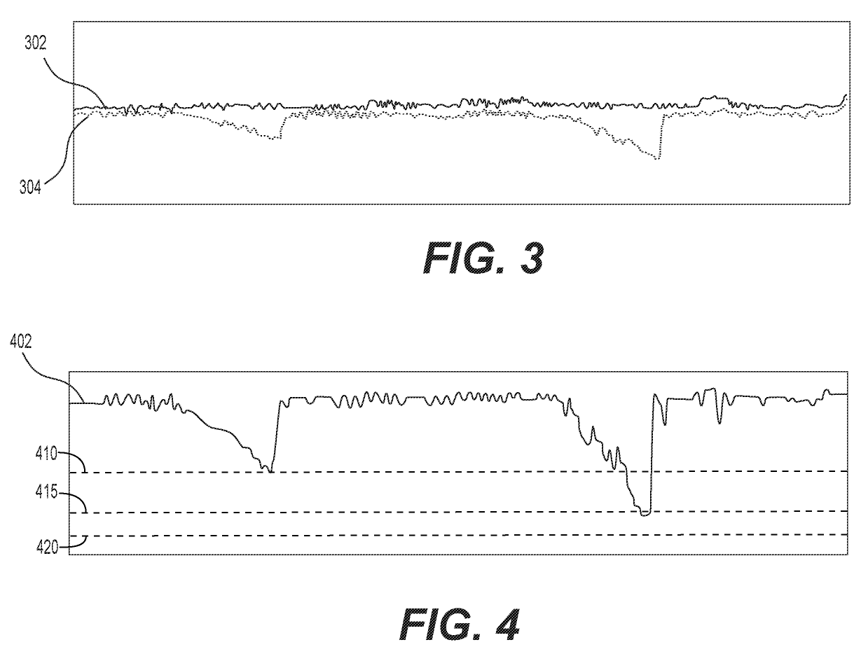

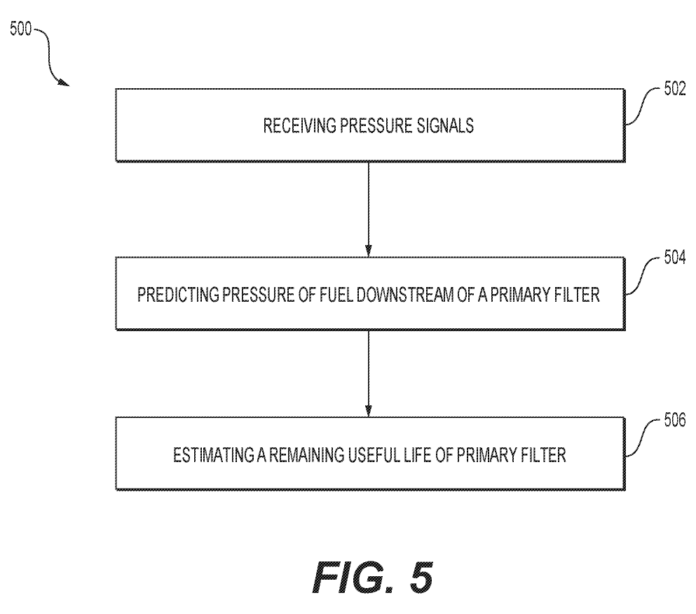

ECM 175 may include a memory, a secondary storage device, processor(s), such as central processing unit(s), networking interfaces, or any other means for accomplishing a task consistent with the present disclosure. The memory or secondary storage device associated with ECM 175 may store data and software to allow ECM 175 to perform its functions, including the functions described below with respect to method 500 (FIG. 5) and the analysis described with respect to FIGS. 3 and 4. In particular, data and software in memory or secondary storage device(s) may allow ECM 175 to perform the modeling, monitoring, signal analysis, engine control (e.g., de-rating), and notification operations described herein. Numerous commercially available microprocessors can be configured to perform the functions of ECM 175. Various other known circuits may be associated with ECM 175, including signal-conditioning circuitry, communication circuitry, display control circuitry, and other appropriate circuitry.

Notification device 185 may include one or more devices or systems configured to output the RUL of primary filter 110 as determined by ECM 175, the RUL being presented in any of the forms described herein. Notification device 185 may include a light or display connected to the engine or provided in a machine (e.g., in an operator cabin), a display of a supervisory device for one or a fleet of machines, a display of a mobile device associated with an operator of the internal combustion engine (e.g., cell phone, laptop), etc. Notification device 185 may be in communication with ECM 175 over a wired or wireless network, such as the Internet, a Local Area Network, WiFi, Bluetooth, or any combination of suitable networking arrangements and protocols. Notification device 185 may include a light or display configured to present one or more of the notifications described below, including an indication when remaining useful life of primary fuel filter 110 is below a first predetermined threshold, an indication when the remaining useful life of fuel filter 110 is below a second predetermined threshold, an indication when the remaining useful life of fuel filter 110 is below a third predetermined threshold, or an indication of the remaining RUL at any desired interval or as requested by a user.

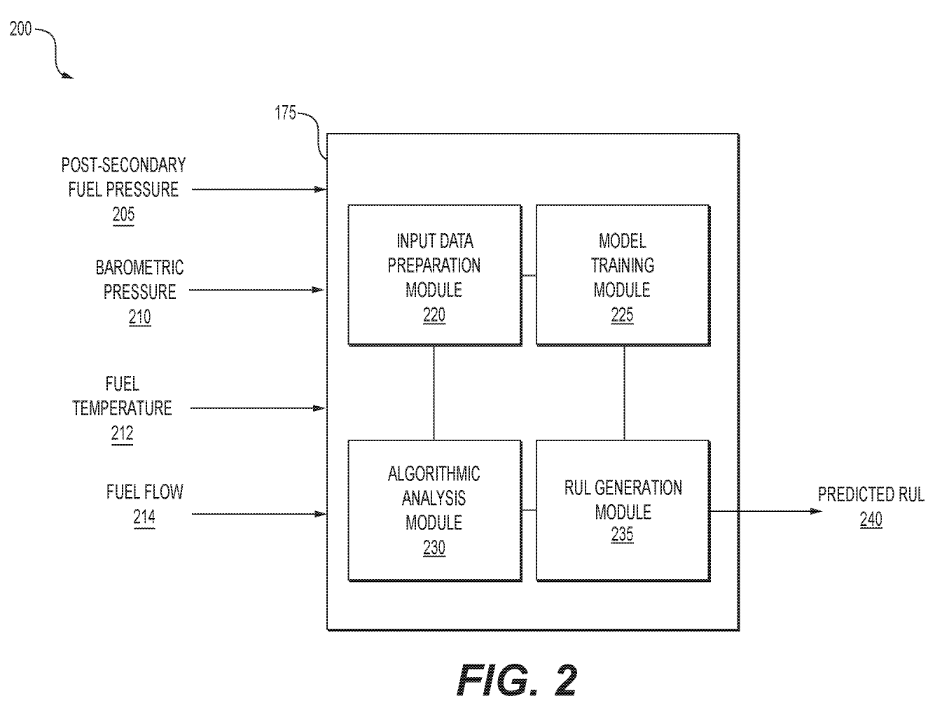

FIG. 2 is a block diagram illustrating an exemplary configuration of ECM 175 useful for monitoring an amount of remaining useful life for one or more components of fuel system 102, such as primary fuel filter 110, based on fuel pressure downstream of secondary fuel filter 140 and barometric pressure. ECM 175 may be implemented as a control module for monitoring system 100 over time, for example during operation of a machine in which the internal combustion engine is installed. In such an implementation, ECM 175 may receive input signals 200 and output a predicted RUL 240 via RUL generation module 235, as described below.

In some configurations, ECM 175 may be implemented as a computing system that analyzes historical data (e.g., data received as input signals 200) and, via modelling, generates maps, lookup tables, or other forms of structured data that facilitate RUL monitoring via RUL generation module 235. For example, input data preparation module 220, model training module 225, and algorithmic analysis module 230 may be implanted with ECM 175 for generating maps or other data for RUL generation module 235. These maps, lookup tables, or other structured data may allow RUL generation module 235 to determine the RUL of filter 110 without the need to employ processor-intensive tasks (e.g., tasks involved with implementation of a machine learning model on ECMs installed for an internal combustion engine of a machine in the field).

In configurations of ECM 175 that are installed on a machine containing fuel system 102, ECM 175 may receive inputs 200 for real-time or near real-time monitoring of system 102. ECM 175 may generate outputs, including predicted RUL 240, as described below, by using maps, lookup tables, etc., that were generated for RUL generation module with modules 220, 225, and 230.

As shown in FIG. 2, input signals 200 to ECM 175 may include a post-secondary filter pressure 205 measured using post-secondary filter sensor 182 and a barometric pressure 210 measured using a barometric pressure sensor 178. In some aspects, a fuel temperature 212 and a fuel flow 214 are optionally measured using sensors or estimated as described above in relation to FIG. 1, engine speed sensors, and others. Given that fuel viscosity changes based on temperature, which affects pressure, fuel temperature 212 and/or fuel flow 214 may be used to improve the accuracy of the calculations discussed herein. Thus, signals 205, 210, 212, and 214 may form input signals 200. Input signals 200 may include other signals useful for ECM 175, such as signals from pre-secondary filter sensor 180, an engine speed sensor, and others.

An input data preparation module 220 may receive signals 200. The signals 200 may be prepared with module 220 for use as training data for one or more models (e.g., machine learning models, artificial intelligence models, physics-based models, etc.). This preparation may include selection of suitable training data, data formatting, data filtering, removal of unreliable or outlying data, etc. Input data preparation module 220 may generate training data such that there is a greater proportion of training data than testing data. Input data preparation module 220 may generate training data by applying the above-described preparation techniques to a subset of input data. The input data may include a plurality of unanalyzed barometric pressure signals, post-secondary fuel filter pressure signals, fuel temperature signals, and fuel flow signals, etc.

A model training module 225 may receive the input data that was prepared by module 220. This data may be used to prepare a model that receives pressures 205 and 210 and outputs a predicted pressure for a location immediately downstream of primary fuel filter 110. Suitable algorithms may incorporate linear regression, random forest, neural network, decision tree, and/or other techniques.

An algorithmic analysis module 230 may compare outputs of a model trained with module 225 to “ground truth” or known outputs (e.g., physically measured pressures or physically-confirmed RUL values) to evaluate the accuracy of the model. If the model is determined to be accurate via algorithmic analysis module 230, the model may be used by module 230 to generate maps, look-up tables, or other techniques that are suitable for implementation with ECM 175 (e.g., via RUL generation module 235). These maps, look-up tables, etc., may receive barometric pressure 210 and a post-secondary fuel pressure 205, and generate an estimated pressure of fuel immediately downstream of primary fuel filter 110 or generate a determined RUL of filter 110 (e.g., a RUL value associated with an estimated pressure). This pressure or RUl value may be used to estimate or track an RUL 240 of primary fuel filter 110 over time.

FIG. 3 is a chart showing post-secondary fuel pressure 304 (e.g., pressure 205 measured with sensor 182). FIG. 3 also shows barometric pressure 302 (e.g., pressure 210 measured with sensor 178). As can be seen in FIG. 3, post-secondary fuel pressure 304 illustrates periods of relative stability (e.g., generally-horizontal areas of pressure 304 in FIG. 3), followed by drops that follow a generally linear trend. As can be seen in FIG. 3, each drop of pressure 304 is followed by a rapid increase. The decrease in pressure 304 indicates that the remaining useful life of the associated filter (e.g., filter 140) was decreasing (e.g., due to accumulation of material that reduces flow through the filter). The increase in pressure 304 indicates that the fuel filter associated with pressure 304 was replaced.

FIG. 4 is a plot showing a predicted pressure 402 associated with primary fuel filter 110. In particular, pressure 402 represents a pressure that is expected to be present immediately downstream of primary fuel filter 110 (see FIG. 1). Predicted pressure 402 may be generated with ECM 175 by using RUL generation module 235 or with a model that was trained via model training module 225. Predicted pressure 402 may be based on based on the post-secondary pressure 304 and barometric pressure 302 shown in FIG. 3, and transformed using one or more maps, lookup tables, etc., created with modules 220, 225, 230, or by use of the modeling techniques described with respect to FIG. 2. Barometric pressure 302 may be used in generating predicted pressure 402 to account for the effect of ambient conditions on various pressures of system 100, such as the pressures of fuel source 105, pump 125, etc.

As shown in FIG. 4, pressure 402 may include a series of generally-linear drops in pressure. The pressure drops in FIG. 4 may correspond to reductions in the RUL of filter 110. ECM 175 of system 100 may therefore be configured to estimate the RUL of filter 110 based on reductions in pressure 402, the estimated RUL being based on barometric pressure and pressure measured with sensor 182 and without the need to include a sensor between filter 110 and pump 125. The RUL may be a value that indicates the difference between the current value of pressure 402 and a lowest acceptable pressure (e.g., the pressure associated with a threshold 410 or a threshold 415, as described below), the lowest acceptable pressure representing no RUL (e.g., 0% RUL or a present need to replace filter 110).

In some aspects, the above-described notifications may be generated as predicted RUL 240, an RUL that is determined and output by RUL generation module 235 (FIG. 2) based on a first threshold 410, a second threshold 415, a third threshold 420, or another value. For example, when ECM 175 determines the RUL of filter 110 has reached the level associated with threshold 410 (e.g., a level at it is recommended to replace fuel filter 110), a first notification may be generated. The first notification may be a recommendation to replace fuel filter 110, a remaining amount of operating hours of filter 110, a percentage representing the RUL of filter 110, etc. In another example, where ECM 175 determines the RUL of filter 110 has reached a lower level associated with threshold 415, a second notification may be generated. The second notification may indicate that filter 110 should be replaced immediately, that filter 110 has little or no RUL, etc. While some notifications have been described with respect to thresholds 410 and 415, as understood, notifications may be presented at any desired timing and frequency.

If desired, in addition to generating a notification, ECM 175 may adjust commands issued to fuel injector 160 (FIG. 1) or other components of the internal combustion engine. For example, upon reaching a third threshold 420 that is associated with diminished performance of filter 110, ECM 175 may de-rate the internal combustion engine by issuing appropriate commands for controlling fuel injector 160. For example, de-rating the engine may include generating commands that cause the engine to operate at less than the associated power rating or maximum power (e.g., by operating at 80% of rated power, 60% of rated power, 40% of rated power, 20% of rated power, or less). The notification issued by ECM 175 may indicate that the engine is being de-rated.

FIG. 5 is a flowchart illustrating an exemplary method 500 for monitoring a remaining useful life of one or more fuel filters of fuel system 102. Method 500 may be performed to monitor the state of fuel system 102 in its entirety, and/or to individually monitor one or more fuel filters 110, 140, of fuel system 102, including filters for which there are no dedicated fuel pressure sensors. Method 500 may be performed continuously or intermittently during operation of system 100.

During step 502, ECM 80 may receive signals 200 (FIG. 2), including pressure signals such as post-secondary filter pressure 205 and barometric pressure 210. If desired, ECM 80 may also receive fuel temperature 212 or fuel flow 214 signals, as described above. In some aspects, signals 200 received at step 502 may be calculated values rather than the above-described values based on measurements made with physical sensors. For example, one or more signals 200 may be signals that allow ECM 175 to function as a virtual pressure sensor that indicates pressure immediately downstream of fuel filter 110.

When signals 200 are used to train a model (e.g., a machine learning model), signals 200 received at step 502 may be prepared using input data preparation module 220 to generate training data. Signals 200 may be prepared via selection of suitable training data, data formatting, data filtering, removal of unreliable or outlying data, etc. The training data may be used by model training module 225 to train a model to output a predicted pressure of fuel downstream of (e.g., immediately downstream of) a primary fuel filter. Any suitable training techniques may be used, such as linear regressions, random forest, etc.

The predicted pressure of fuel downstream of the primary filter may be used by algorithmic analysis module 230 to evaluate the accuracy of the model that was trained by model training module 225. If the model is determined to be accurate via algorithmic analysis module 230, the model may be used by a map generator module 235 to generate maps, look-up tables, or other techniques that are suitable for implementation with ECM 175. These maps, look-up tables, etc., may receive post-secondary filter pressure 205 and barometric pressure 210, and generate an estimated post-primary fuel filter pressure.

At step 504, a pressure at the location immediately downstream of primary fuel filter 110 may be predicted. The fuel pressure downstream of primary fuel filter 110 may be predicted, for example, using a pre-generated model. The model may predict the fuel pressure at an outlet of filter 110 based on post-secondary fuel pressure 205 and barometric pressure 210. Step 504 may be performed using a model that was trained based on previously-received barometric pressure and fuel pressure signals, or by using structured data, such as lookup tables or maps, that were generated using previously-received pressure signals.

At step 506, this predicted pressure may be used to estimate or track an RUL 240 (FIG. 2) of primary fuel filter 110, as described above. In some aspects, ECM 175 may determine that a RUL 240 of primary fuel filter 110 has exceeded a threshold or may generate another notification of the determined RUL. For example, when ECM 175 determines that RUL 240 of primary fuel filter 110 has exceeded a first threshold, such as threshold 410 depicted in FIG. 4, ECM 175 may generate a first notification. In another example, when ECM 175 determines the RUL 240 of primary fuel filter 110 has exceeded a second threshold, such as threshold 415 depicted in FIG. 4, ECM 175 may generate a second notification. When ECM 175 determines that RUL 240 of fuel filter 110 has exceeded a third threshold, such as threshold 420 in FIG. 4, ECM 175 may generate a notification and de-rate the associated engine or take other actions that adjust the operation of the engine.

The notifications, for example of RUL 240, may indicate a remaining life of primary filter 110 as a percentage value (e.g., a value that gradually decreases from 100%), a remaining amount of operating hours for filter 110, a recommendation to replace filter 110, an indication that replacement of filter 110 is needed, or an indication that the engine is currently being de-rated. ECM 175 may cause the notifications to be output via a display associated with notification device 185. The notification may be generated in response to exceeding one or more thresholds, at startup or shutdown of system 100, continuously during operation of system 100, or at any other desired time.

While steps 502, 504, and 506 of method 500 were described in an exemplary order, and are shown in an exemplary order in FIG. 5, as understood, one or more of the steps may be performed in a different order, at partially or entirely overlapping periods of time, etc. Additionally, one or more of the steps 502, 504, 506, and other aspects of method 500 may be performed intermittently during the operation of fuel system 102, while one or more other steps or aspects of method 500 may be performed continuously during operation of fuel system 102.

The disclosed system and method may be configured to monitor remaining life of one or more fuel filters of a fuel system for an internal combustion engine. In particular, the system and method may be configured to determine RUL for a fuel filter for which a fuel pressure sensor is not provided at a location immediately downstream of the fuel filter. In some aspects, the RUL of this filter may be monitored based on downstream pressure. In particular, sensors, such as atmospheric pressure and post-secondary fuel filter pressure may be utilized by the system and method, reducing the number of physical fuel pressure sensors that are used. The control module may be configured to generate a model, or use data generated via the model, to determine remaining useful life of the primary fuel filter. The model may incorporate machine learning techniques, and may provide the ability to guide filter changes. The system may be able to adjust for changing conditions including engine operation, fuel cleanliness, or location of the system without the requirement of an additional post-primary fuel pressure sensor.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

What is claimed is:

1. A fuel filter monitoring system, the system comprising:
a fuel supply system including a primary fuel filter and a secondary fuel filter;
a sensor system including:
a barometric pressure sensor; and
a fuel pressure sensor connected downstream of the secondary fuel filter, the sensor system being configured to generate a barometric pressure signal with the barometric pressure sensor and a fuel pressure signal with the fuel pressure sensor; and
a controller configured to estimate a remaining life associated with the primary fuel filter based on the barometric pressure signal and the fuel pressure signal.

2. The fuel filter monitoring system of claim 1, further comprising:
a fuel supply pump connected upstream of the secondary fuel filter, the system including no fuel pressure sensor connected between the fuel supply pump and the primary fuel filter.

3. The fuel filter monitoring system of claim 1, further comprising:
a pressurizing pump connected downstream of the secondary fuel filter, the fuel pressure sensor being connected between the secondary fuel filter and the pressurizing pump.

4. The fuel filter monitoring system of claim 1, the sensor system further comprising a fuel pressure sensor connected upstream of the secondary fuel filter.

5. The fuel filter monitoring system of claim 1, the sensor system further comprising:
a fuel condition sensor configured to measure a fuel temperature; or
a fuel flow sensor configured to measure a fuel flow.

6. The fuel filter monitoring system of claim 5, wherein the controller is further configured to estimate the remaining life associated with the primary fuel filter based on the fuel temperature or the fuel flow.

7. The fuel filter monitoring system of claim 1, the controller further configured to output a notification indicative of the remaining life associated with the primary fuel filter.

8. A fuel filter monitoring method, comprising:
receiving a barometric pressure signal from a barometric pressure sensor of a fuel supply system, the fuel supply system including a first fuel filter and a second fuel filter, the second fuel filter being connected downstream of the first fuel filter;
receiving a fuel pressure signal from a fuel pressure sensor of the fuel supply system, the fuel pressure sensor being connected downstream of the second fuel filter; and
determining a remaining useful life of the first fuel filter based on the barometric pressure signal and the fuel pressure signal.

9. The fuel filter monitoring method of claim 8, further comprising:
receiving one or both of a fuel temperature signal from a fuel condition sensor or a fuel flow signal from a fuel flow sensor.

10. The fuel filter monitoring method of claim 8, further comprising:
determining a pressure of fuel at a location downstream of the first fuel filter of the fuel supply system based on the barometric pressure signal and the fuel pressure signal, the remaining useful life of the first fuel filter being determined based on the determined pressure of fuel downstream of the first fuel filter.

11. The fuel filter monitoring method of claim 10, wherein the pressure downstream of the first fuel filter is predicted using a modelling technique.

12. The fuel filter monitoring method of claim 11, wherein the modeling technique includes use of a machine learning model that has been trained using based on a plurality of training data a barometric pressure signals and fuel pressure signals.

13. The fuel filter monitoring method of claim 12, further comprising:
programming an electronic control module with data based on outputs of the machine learning model.

14. The fuel filter monitoring method of claim 13, wherein the training data is generated such that there is a greater proportion of training data than testing data.

15. The fuel filter monitoring method of claim 8, wherein the pressure at a location immediately downstream of the first fuel filter is estimated using at least one map generated by a trained machine learning model.

16. The fuel filter monitoring method of claim 11, wherein the pressure at the location downstream of the first fuel filter is determined using at least one look-up table or map.

17. A method for monitoring a fuel filter, the method comprising:
receiving an atmospheric pressure signal from a pressure sensor of a fuel supply system;
receiving a fuel pressure signal from a fuel pressure sensor of the fuel supply system, the fuel pressure sensor being connected downstream of a first fuel filter and downstream of a second fuel filter;
determining a pressure at a location downstream of the first fuel filter based on the atmospheric pressure signal and the fuel pressure signal; and
determining a remaining useful life of the first fuel filter based on the determined pressure.

18. The method of claim 17, further comprising:
receiving one or both of a fuel temperature signal from a fuel condition sensor or a fuel flow signal from a fuel flow sensor.

19. The method of claim 17, further comprising:
determining, via trained machine learning model, the pressure at the location downstream of the first fuel filter or the remaining useful life of the first fuel filter.

20. The method of claim 19, further including programming an electronic control module based on outputs from the trained machine learning model.
